(19) United States
(12) Patent Application Publication
(10) Pub. No.: US 2015/0208679 A1
(43) Pub. Date: Jul. 30, 2015

(54) METHODS OF HANDLING AVOCADOS AND SYSTEM

(71) Applicant: AgroFresh, Inc., Collegeville, PA (US)

(72) Inventors: Nazir Mir, Somerset, NJ (US); Rodrigo A. Cifuentes, Santiago (CL); Evan McCaskey, Ambler, PA (US); Aishwarya Balasubramanian, Somerset, NJ (US); Fernando K. Edagi, Davis, CA (US); William Nixon James, Hatfield, PA (US); Robert L. McGee, Midland, MI (US)

(21) Appl. No.: 14/417,534

(22) PCT Filed: Jul. 19, 2013
(86) PCT No.: PCT/US13/51306

§ 371 Date: Jan. 26, 2015

Related U.S. Application Data
(60) Provisional application No. 61/675,488, filed on Jul. 25, 2012.

(51) Int. Cl. A23B 7/152

(52) U.S. Cl. CPC A23B 7/152; A23V 2002/00

(57) ABSTRACT

This invention is based on unexpected synergistic effect of a cyclopropene compound and a modified atmosphere package to extend shelf life and/or storage for avocados. Provided is a method of storing avocados comprising the step of exposing avocados to an atmosphere that contains a cyclopropene compound, wherein either (a) the avocados are in a modified-atmosphere package during exposure to the cyclopropene compound, or (b) the avocados are placed into a modified-atmosphere package after exposure to the cyclopropene compound, and the avocados remain in the modified atmosphere package for at least two hours. In some embodiments, the modified-atmosphere package is constructed so that the transmission rate of oxygen for the entire package is from 200 to 40,000 cubic centimeters per day per kilogram of avocados.

### BACKGROUND OF THE INVENTION

Avocados are normally harvested prior to full ripeness, usually when the avocados have dry matter content of 19% to 23% by weight, depending on the variety. Usually, at the time of harvest, avocados remain harder than is desirable for consumption. It is common to harvest and then ship avocados while the fruit has pulp firmness of approximately 180 to 360 Newtons (40 to 80 lbf), depending on the variety. After harvest, avocados are commonly shipped, sometimes for long distances, at low temperature (for example, at 3 to 6° C.). During such shipment, Avocados normally remain relatively hard and are considered to ripen very slowly, if at all.

Commonly, when avocados arrive at a destination (the “processing point”) that is near to the location at which they will be sold or consumed, they are exposed to conditions that are intended to trigger or speed up the ripening process. Commonly, avocados are exposed to higher temperatures for a time, usually approximately 20° C. for approximately one day. In some cases, Avocados are also exposed to ethylene.

After the ripening process is triggered or sped up, the avocados ripen quickly. The ripening process causes the firmness of the pulp to decrease. Commonly, avocados are shipped from the processing point when the pulp firmness is 65 to 120 Newtons (15 to 25 lbf). The pulp firmness that is most desirable for sale and consumption is 22 to 44 Newtons (5 to 10 lbf). When the pulp firmness falls below 10 Newtons (2 lbf), the avocados are so soft that vendors cannot sell them without large and undesirable reductions in price. Typically, the time from shipment until the avocados become too soft to sell is 3 days or less, which is undesirably short.

It is desirable to maintain avocados for as long as possible in a desirable condition (i.e., a condition in which they are desirable to consumers). Avocados in that condition are ripe but have not developed undesirable post-ripening characteristics such as, for example, one or more of the following: pulp that has turned undesirably brown, or pulp that has turned undesirably soft.

WO 2011/082059 describes a method of storing bananas that involves exposing the bananas to an ethylene-active compound, exposing the bananas to a cyclopropene compound when the bananas have a certain color, and keeping the bananas in a modified atmosphere package.

Thus, there is a need for effective and efficient methods to handle avocados for retail sale and/or consumption for a longer time than before, as well as effective and efficient methods of storing and handling avocados that allows the avocados to remain fresh for a longer time in condition that is desirable for consumer consumption.

### SUMMARY OF THE INVENTION

This invention is based on unexpected synergistic effect of a cyclopropene compound and a modified atmosphere package to extend shelf life and/or storage for avocados. Provided is a method of storing avocados comprising the step of exposing avocados to an atmosphere that contains a cyclopropene compound, wherein either (a) the avocados are in a modified-atmosphere package during exposure to the cyclopropene compound, or (b) the avocados are placed into a modified-atmosphere package after exposure to the cyclopropene compound, and the avocados remain in the modified atmosphere package for at least two hours. In some embodiments, the modified-atmosphere package is constructed so that the transmission rate of oxygen for the entire package is from 200 to 40,000 cubic centimeters per day per kilogram of avocados.

In one aspect, provided is a method of handling avocados comprising exposing the avocados to an atmosphere that contains a cyclopropene compound, wherein the avocados are in a modified-atmosphere package during exposure to the cyclopropene compound and the avocados remain in the modified atmosphere package after the exposure for at least two hours.

In one embodiment, the modified-atmosphere package is constructed so that the transmission rate of oxygen for the entire package is from 200 to 40,000 cubic centimeters per day per kilogram of avocados. In a further embodiment, the transmission rate of carbon dioxide for the entire package is from 500 to 150,000 cubic centimeters per day per kilogram of avocados. In a further embodiment, the transmission rate of carbon dioxide for the entire package is from 3,800 to 72,000 cubic centimeters per day per kilogram of avocados. In another embodiment, the modified-atmosphere package is constructed so that the transmission rate of carbon dioxide for the entire package is from 5,000 to 150,000 cubic centimeters per day per kilogram of avocados. In another embodiment, the exposure to the cyclopropene compound begins when the avocados have pulp firmness of 65 to 150 Newtons. In another embodiment, the avocados remain in the modified atmosphere package after the exposure for at least ten hours, twenty hours, forty hours, four days, seven days, or ten days. In another embodiment, the cyclopropene compound is in a formulation with a molecular encapsulating agent. In a further embodiment, the cyclopropene compound comprises 1-methylcyclopropene (1-MCP). In another embodiment, the molecular encapsulating agent comprises alpha-cyclodextrin, beta-cyclodextrin, gamma-cyclodextrin, or combinations thereof. In a further embodiment, the encapsulated agent comprises alpha-cyclodextrin.

In one embodiment, the cyclopropene compound is of the formula:

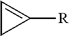

wherein R is a substituted or unsubstituted alkyl, alkenyl, alkynyl, cycloalkyl, cycloalkylalkyl, phenyl, or naphthyl group; wherein the substituents are independently halogen, alkoxy, or substituted or unsubstituted phenoxy.

In a further embodiment, R is C₁₋₈ alkyl. In another embodiment, R is methyl.

In another embodiment, the cyclopropene compound is of the formula:

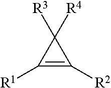

wherein R¹ is a substituted or unsubstituted C₁-C₄ alkyl, C₁-C₄ alkenyl, C₁-C₄ alkynyl, C₁-C₄ cycloalkyl, cylcoalkylalkyl, phenyl, or napthyl group; and R², R³, and R⁴ are hydrogen.

In another embodiment, the cyclopropene compound during the exposure is at a concentration between 10 ppb and 5 ppm. In a further embodiment, the cyclopropene compound during the exposure is at a concentration about 1,000 ppb. In another embodiment, the firmness of the avocados after the exposure is at least sixteen lbfs after day one or fourteen lbfs after day seven. In another embodiment, shelf life of the avocados after the exposure is at least five days, ten days, fifteen days, twenty days, thirty days, forty days, fifty days, or sixty days. In another embodiment, the avocados are placed in the modified-atmosphere package within two hours, four hours, eight hours, twelve hours, twenty-four hours, or forty-eight hours after harvest.

In another aspect, provided is a method of handling avocados comprising exposing the avocados to an atmosphere that contains a cyclopropene compound, wherein the avocados are placed into a modified-atmosphere package within two hours after exposure to the cyclopropene compound, and the avocados remain in the modified atmosphere package for at least two hours.

In one embodiment, the modified-atmosphere package is constructed so that the transmission rate of oxygen for the entire package is from 200 to 40,000 cubic centimeters per day per kilogram of avocados. In a further embodiment, the transmission rate of carbon dioxide for the entire package is from 500 to 150,000 cubic centimeters per day per kilogram of avocados. In a further embodiment, the transmission rate of carbon dioxide for the entire package is from 3,800 to 72,000 cubic centimeters per day per kilogram of avocados. In another embodiment, the modified-atmosphere package is constructed so that the transmission rate of carbon dioxide for the entire package is from 5,000 to 150,000 cubic centimeters per day per kilogram of avocados. In another embodiment, the exposure to the cyclopropene compound begins when the avocados have pulp firmness of 65 to 150 Newtons. In another embodiment, the avocados are placed into a modified-atmosphere package within four hours, eight hours, twelve hours, or twenty hours after exposure to the cyclopropene compound. In another embodiment, the avocados remain in the modified atmosphere package after the exposure for at least ten hours, twenty hours, forty hours, four days, seven days, or ten days. In another embodiment, the cyclopropene compound is in a formulation with a molecular encapsulating agent. In a further embodiment, the cyclopropene compound comprises 1-methylcyclopropene (1-MCP). In another embodiment, the molecular encapsulating agent comprises alpha-cyclodextrin, beta-cyclodextrin, gamma-cyclodextrin, or combinations thereof. In a further embodiment, the encapsulated agent comprises alpha-cyclodextrin.

In one embodiment, the cyclopropene compound is of the formula:

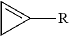

wherein R is a substituted or unsubstituted alkyl, alkenyl, alkynyl, cycloalkyl, cycloalkylalkyl, phenyl, or naphthyl group; wherein the substituents are independently halogen, alkoxy, or substituted or unsubstituted phenoxy.

In a further embodiment, R is C₁₋₈ alkyl. In another embodiment, R is methyl.

In another embodiment, the cyclopropene compound is of the formula:

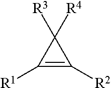

wherein R¹ is a substituted or unsubstituted C₁-C₄ alkyl, C₁-C₄ alkenyl, C₁-C₄ alkynyl, C₁-C₄ cycloalkyl, cylcoalkylalkyl, phenyl, or napthyl group; and R², R³, and R⁴ are hydrogen.

In another embodiment, the cyclopropene compound during the exposure is at a concentration between 10 ppb and 5 ppm. In a further embodiment, the cyclopropene compound during the exposure is at a concentration about 1,000 ppb. In another embodiment, the firmness of the avocados after the exposure is at least sixteen lbfs after day one or fourteen lbfs after day seven. In another embodiment, shelf life of the avocados after the exposure is at least five days, ten days, fifteen days, twenty days, thirty days, forty days, fifty days, or sixty days.

In another aspect, provided is a system for handling avocados comprising (a) a cyclopropene compound, wherein the cyclopropene compound is applied to the avocados at a concentration between 10 ppb and 5 ppm; and (b) a modified-atmosphere package, wherein the modified-atmosphere package is constructed so that the transmission rate of oxygen for the entire package is from 200 to 40,000 cubic centimeters per day per kilogram of avocados.

In one embodiment of the system provided, the transmission rate of carbon dioxide for the entire package is from 500 to 150,000 cubic centimeters per day per kilogram of avocados. In a further embodiment, the transmission rate of carbon dioxide for the entire package is from 3,800 to 72,000 cubic centimeters per day per kilogram of avocados. In another embodiment, the modified-atmosphere package is constructed so that the transmission rate of carbon dioxide for the entire package is from 5,000 to 150,000 cubic centimeters per day per kilogram of avocados. In another embodiment, the exposure to the cyclopropene compound begins when the avocados have pulp firmness of 65 to 150 Newtons. In another embodiment, the cyclopropene compound is in a formulation with a molecular encapsulating agent. In a further embodiment, the cyclopropene compound comprises 1-methylcyclopropene (1-MCP). In another embodiment, the molecular encapsulating agent comprises alpha-cyclodextrin, beta-cyclodextrin, gamma-cyclodextrin, or combinations thereof. In a further embodiment, the encapsulated agent comprises alpha-cyclodextrin.

In one embodiment, the cyclopropene compound is of the formula:

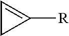

wherein R is a substituted or unsubstituted alkyl, alkenyl, alkynyl, cycloalkyl, cycloalkylalkyl, phenyl, or naphthyl group; wherein the substituents are independently halogen, alkoxy, or substituted or unsubstituted phenoxy.

In a further embodiment, R is C₁₋₈ alkyl. In another embodiment, R is methyl.

In another embodiment, the cyclopropene compound is of the formula:

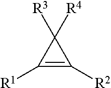

wherein R¹ is a substituted or unsubstituted C₁-C₄ alkyl, C₁-C₄ alkenyl, C₁-C₄ alkynyl, C₁-C₄ cycloalkyl, cylcoalkylalkyl, phenyl, or napthyl group; and R², R³, and R⁴ are hydrogen.

In another embodiment, the cyclopropene compound is applied to the avocados at a concentration about 1,000 ppb. In another embodiment, the firmness of the avocados after treatment with the system provided is at least sixteen lbfs after day one or fourteen lbfs after day seven. In another embodiment, shelf life of the avocados after the treatment with the system provided is at least five days, ten days, fifteen days, twenty days, thirty days, forty days, fifty days, or sixty days.

### BRIEF DESCRIPTION OF THE DRAWINGS

FIG. 1 shows representative oxygen (O₂) concentrations of samples tested with the method provided (RipeLock), modified atmosphere package alone (MAP), cyclopropene compound alone (SmartFresh), or control (without neither modified atmosphere package nor cyclopropene compound).

FIG. 2 shows representative carbon dioxide (CO₂) concentrations of samples tested with the method provided (RipeLock), modified atmosphere package alone (MAP), cyclopropene compound alone (SmartFresh), or control (without neither modified atmosphere package nor cyclopropene compound).

FIG. 3 shows representative skin color of avocados tested with the method provided (RipeLock), modified atmosphere package alone (MAP), cyclopropene compound alone (SmarFresh), or control (without neither modified atmosphere package nor cyclopropene compound).

FIG. 4 shows representative data of pulp firmness of avocados tested with the method provided (RipeLock), modified atmosphere package alone (MAP), cyclopropene compound alone (SmarFresh), or control (without neither modified atmosphere package nor cyclopropene compound).

FIG. 5 shows representative firmness results indicating synergistic effect for MAP bags and SmartFresh (1-methylcyclopropene or 1-MCP) applications.

FIG. 6 shows representative firmness results of avocados tested (with ethylene) and FIG. 7 shows other representative firmness results of avocados tested (without ethylene).

FIG. 8 shows skin colors of avocados tested (with ethylene).

### DETAILED DESCRIPTION OF THE INVENTION

When a compound is described herein as being present as a gas in an atmosphere at a certain concentration using the unit “ppm,” the concentration is given as parts by volume of that compound per million parts by volume of the atmosphere. Similarly, “ppb” denotes parts by volume of that compound per billion parts by volume of the atmosphere.

As used herein “N” denotes Newtons, and “lbf” is pounds-force.

As used herein, a “polymeric film” is an object that is made of polymer; that is much smaller in one dimension (the “thickness”) than in the other two dimensions; and that has a relatively uniform thickness. Polymeric film typically has thickness of 1 mm or less.

As used herein, the “pulp firmness” of an avocado is measured using a penetrometer (Fruit Test™ FT40 penetrometer, from Wagner Instruments) having a plunger diameter of 8 mm. Performing the test for pulp firmness destroys the avocado that is tested. When avocados are said herein to be treated in a certain way (e.g., harvested, shipped, exposed to a cyclopropene compound, etc.) when they have a certain specified pulp firmness, it is meant that, out of a group of avocados that have been harvested and treated as uniformly as reasonably possible, a sample of a relatively small number of avocados is removed and tested for pulp firmness. The large group of avocados is considered to have the pulp firmness that is the average value of the tests performed on the relatively small sample.

The present invention involves the use of one or more cyclopropene compound. As used herein a cyclopropene compound is any compound with the formula

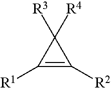

where each R¹, R², R³ and R⁴ is independently selected from the group consisting of H and a chemical group of the formula:

-(L)ₙ-Z

where n is an integer from 0 to 12. Each L is a bivalent radical. Suitable L groups include, for example, radicals containing one or more atoms selected from H, B, C, N, O, P, S, Si, or mixtures thereof. The atoms within an L group may be connected to each other by single bonds, double bonds, triple bonds, or mixtures thereof. Each L group may be linear, branched, cyclic, or a combination thereof. In any one R group (i.e., any one of R¹, R², R³ and R⁴) the total number of heteroatoms (i.e., atoms that are neither H nor C) is from 0 to 6.

Independently, in any one R group the total number of non-hydrogen atoms is 50 or less.

Each Z is a monovalent radical. Each Z is independently selected from the group consisting of hydrogen, halo, cyano, nitro, nitroso, azido, chlorate, bromate, iodate, isocyanato, isocyanido, isothiocyanato, pentafluorothio, and a chemical group G, wherein G is a 3 to 14 membered ring system.

The R¹, R², R³ and R⁴ groups are independently selected from the suitable groups. The R¹, R², R³ and R⁴ groups may be the same as each other, or any number of them may be different from the others. Groups that are suitable for use as one or more of R¹, R², R³ and R⁴ may be connected directly to the cyclopropene ring or may be connected to the cyclopropene ring through an intervening group such as, for example, a heteroatom-containing group.

As used herein, a chemical group of interest is said to be “substituted” if one or more hydrogen atoms of the chemical group of interest is replaced by a substituent. Suitable substituents include, for example, alkyl, alkenyl, acetylamino, alkoxy, alkoxyalkoxy, alkoxycarbonyl, alkoxyimino, carboxy, halo, haloalkoxy, hydroxy, alkylsulfonyl, alkylthio, trialkylsilyl, dialkylamino, and combinations thereof.

Among the suitable R¹, R², R³ and R⁴ groups are, for example, substituted and unsubstituted versions of any one of the following groups: aliphatic, aliphatic-oxy, alkylcarbonyl, alkylphosphonato, alkylphosphato, alkylamino, alkylsulfonyl, alkylcarboxyl, alkylaminosulfonyl, cycloalkylsulfonyl, cycloalkylamino, heterocyclyl (i.e., aromatic or non-aromatic cyclic groups with at least one heteroatom in the ring), aryl, hydrogen, fluoro, chloro, bromo, iodo, cyano, nitro, nitroso, azido, chlorato, bromato, iodato, isocyanato, isocyanido, isothiocyanato, pentafluorothio; acetoxy, carboethoxy, cyanato, nitrato, nitrito, perchlorato, allenyl; butylmercapto, diethylphosphonato, dimethylphenylsilyl, isoquinolyl, mercapto, naphthyl, phenoxy, phenyl, piperidino, pyridyl, quinolyl, triethylsilyl, and trimethylsilyl.

Among the suitable R¹, R², R³ and R⁴ groups are those that contain one or more ionizable substituent groups. Such ionizable groups may be in non-ionized form or in salt form.

Also contemplated are embodiments in which R³ and R⁴ are combined into a single group, which is attached to the number 3 carbon atom of the cyclopropene ring by a double bond. Some of such compounds are described in US Patent Publication 2005/0288189.

In preferred embodiments, one or more cyclopropenes are used in which one or more of R¹, R², R³ and R⁴ is hydrogen. In more preferred embodiments, each of R¹, R², R³ and R⁴ is hydrogen or (C1-C8) alkyl. In more preferred embodiments, R¹ is substituted or unsubstituted (C1-C8) alkyl, and each of R², R³, and R⁴ is hydrogen. In more preferred embodiments, each of R², R³, and R⁴ is hydrogen, and R¹ is either unsubstituted (C1-C4) alkyl or a carboxyl-substituted (C1-C8) alkyl. In more preferred embodiments, each of R², R³, and R⁴ is hydrogen, and R¹ is unsubstituted (C1-C4) alkyl. In more preferred embodiments, R¹ is methyl and each of R², R³, and R⁴ is hydrogen, and the cyclopropene compound is known herein as “1-MCP.”

In preferred embodiments, a cyclopropene compound is used that has boiling point at one atmosphere pressure of 50° C. or lower; or 25° C. or lower; or 15° C. or lower. Independently, in preferred embodiments, a cyclopropene compound is used that has boiling point at one atmosphere pressure of −100° C. or higher; −50° C. or higher; or 25° C. or higher; or 0° C. or higher.

As used herein, “modified-atmosphere packaging” (“MAP”) is an enclosure that alters the gaseous atmosphere inside the enclosure from normal atmospheric composition when respiring produce is contained inside the enclosure. MAP is an enclosure in the sense that it is a package that may be lifted and transported with the produce contained within it. MAP may or may not allow exchange of gas with the ambient atmosphere outside the MAP. MAP may or may not be permeable to diffusion of any particular gas, independent of its permeability or non-permeability to any other gas.

As used herein, a “monomer” is a compound that has one or more carbon-carbon double bond that is capable of participating in a polymerization reaction. As used herein, an “olefin monomer” is a monomer, the molecules of which contain only atoms of carbon and hydrogen. As used herein, “polar monomer” is a monomer, the molecules of which contain one or more polar group. Polar groups include, for example, hydroxyl, thiol, carbonyl, carbon-sulfur double bond, carboxyl, sulfonic acid, ester linkages, other polar groups, and combinations thereof.

Preferably, avocados are subjected to a ripening cycle. In a typical ripening cycle, avocados are stored in a normal atmosphere at 15° C. to 25° C. for 12 to 36 hours. In a preferred ripening cycle, avocados are exposed to a normal atmosphere for 20-28 hours at 18° C. to 22° C. Optionally, the ripening cycle may also include exposing the avocados to an atmosphere that contains ethylene. Preferably, ripening cycle is performed after harvest. Preferably, ripening cycle is performed at a location that is near to the point of consumption or sale.

After a ripening cycle, avocados are preferably stored at 15 to 25° C. in a normal atmosphere until they have pulp firmness of 65 N to 150 N (15 lbf to 34 lbf).

In the method of the present invention, avocados having pulp firmness of 65 N to 150 N (15 lbf to 34 lbf) are exposed to an atmosphere that contains one or more cyclopropene compound. Cyclopropene compound may be introduced into the atmosphere surrounding the avocados by any method. For example, gaseous cyclopropene compound may be released into the atmosphere in such close proximity to avocados that the cyclopropene compound contacts the avocados before the cyclopropene diffuses far away from the avocados. For another example, the avocados may be in an enclosure (i.e., and airtight container enclosing a volume of atmosphere), and gaseous cyclopropene compound may be introduced into the enclosure.

In some embodiments, the avocados are inside a permeable surrounding device, and cyclopropene compound is introduced into the atmosphere outside the permeable surrounding device. In such embodiments, the permeable surrounding device encloses one or more avocados and allows some contact between the cyclopropene compound and the avocados, for example by allowing some cyclopropene compound to diffuse through the permeable surrounding device or through holes in the permeable surrounding device or a combination thereof. Such a permeable surrounding device may or may not also qualify as an MAP as defined herein.

Among embodiments in which gaseous cyclopropene compound is introduced into an enclosure, the introduction may be performed by any method. For example, the cyclopropene compound may be created in a chemical reaction and vented to the enclosure. For another example, cyclopropene compound may be kept in a container such as a compressed-gas tank and released from that container into the enclosure. For another example, cyclopropene compound may be contained in a powder or pellets or other solid form that contains encapsulated complex of cyclopropene compound in a molecular encapsulation agent. Such a complex is known herein as a “cyclopropene encapsulated complex.”

In embodiments in which a molecular encapsulation agent is used, suitable molecular encapsulation agents include, for example, organic and inorganic molecular encapsulating agents. Preferred are organic molecular encapsulation agents. Preferred organic encapsulation agents include, for example, substituted cyclodextrins, unsubstituted cyclodextrins, and crown ethers. Suitable inorganic molecular encapsulation agents include, for example, zeolites. Mixtures of suitable molecular encapsulation agents are also suitable. In preferred embodiments of the invention, the encapsulation agent is alpha cyclodextrin, beta cyclodextrin, gamma cyclodextrin, substituted versions thereof, or a mixture thereof. In some embodiments of the invention, particularly when the cyclopropene compound is 1-methylcyclopropene, the preferred encapsulation agent is alpha cyclodextrin. The preferred encapsulation agent will vary depending upon the structure of the cyclodextrin compound or compounds being used. Any cyclodextrin or mixture of cyclodextrins, cyclodextrin polymers, modified cyclodextrins, or mixtures thereof can also be utilized pursuant to the present invention.

In some embodiments, a cyclopropene compound is introduced into an enclosure that contains avocados by placing cyclopropene encapsulation complex into the enclosure and then contacting the cyclopropene encapsulation complex with a release agent. A release agent is a compound that, when it contacts cyclopropene encapsulation complex, promotes the release of the cyclopropene compound into the atmosphere. Among embodiments in which alpha-cyclodextrin is used, water (or a liquid that contains 50% or more water by weight, based on the weight of the liquid) is the preferred release agent.

In preferred embodiments, a solid material containing cyclopropene encapsulation complex is placed into an enclosure that contains avocados, and water is brought into contact with that solid material. Contact with the water causes release of cyclopropene compound into the atmosphere of the enclosure. For example, the solid material may be in the form of tablets that contain, optionally among other ingredients, encapsulation complex that contains a cyclopropene compound and one or more ingredients that causes effervescence.

For another example, in some embodiments the solid material may be placed into an enclosure that contains avocados, and water vapor in the atmosphere may be effective as a release agent. In some of such embodiments, the solid material that contains cyclopropene encapsulated complex may be in a form that also contains, optionally among other ingredients, a water-absorbing compound such as, for example, a water-absorbing polymer or a deliquescent salt.

In preferred embodiments of the present invention, atmosphere containing one or more cyclopropene compound in gaseous form is in contact with avocados (or is in contact with a permeable surrounding device that surrounds one or more avocado). In such embodiments, all concentrations above zero of cyclopropene compound are contemplated. Preferably, the concentration of cyclopropene compound is 10 ppb or higher; more preferably is 30 ppb or higher; more preferably is 100 ppb or higher. Preferably, the concentration of cyclopropene compound is 50 ppm or lower, more preferably 10 ppm or lower, more preferably 5 ppm or lower.

MAP may be active or passive. Active MAP is packaging that is attached to some material or apparatus that adds certain gas or gases to the atmosphere inside the MAP and/or removes certain gas or gases from the atmosphere inside the MAP.

Passive MAP (also called commodity generated modified atmosphere packaging) takes advantage of the fact that avocados respire after harvest. Thus avocados placed in an enclosure, among other processes, consume oxygen and produce carbon dioxide. The MAP can be designed so that diffusion through the solid exterior surfaces of the MAP and passage of gas through any perforations that may be present in the exterior surface of the MAP maintain optimum levels of oxygen, carbon dioxide, and optionally other gases (such as, for example, water vapor or ethylene or both). In preferred embodiments, passive MAP is used.

Also contemplated are embodiments that employ active MAP. In the specification and claims herein, if MAP is not specifically stated to be active or passive, it is intended that the MAP may be either active or passive. For example, if it is stated herein that an MAP has a certain gas transmission characteristic, both of the following embodiments are contemplated: a passive MAP that has that gas transmission characteristic; and an active MAP that, when it contains avocados, maintains the same atmosphere within itself that would occur in a passive MAP that had that gas transmission characteristic.

A useful way to characterize the MAP is the gas transmission rate of the MAP itself in relation to the amount of avocados held in the MAP. Preferably, the rate of transmission of carbon dioxide is, in units of cubic centimeters per day per kilogram of avocados, 5,000 or higher; more preferably 7,000 or higher; more preferably 10,000 or higher. Preferably, the rate of transmission of carbon dioxide is, in units of cubic centimeters per day per kilogram of avocados, 150,000 or lower; more preferably 100,000 or lower. Preferably, the rate of transmission of oxygen is, in units of cubic centimeters per day per kilogram of avocados, 3,800 or higher; more preferably 7,000 or higher; more preferably 15,000 or higher. Preferably, the rate of transmission of oxygen is, in units of cubic centimeters per day per kilogram of avocados, 100,000 or lower; or 75,000 or lower.

It is useful to characterize the inherent gas transmission characteristics of a polymeric film. By “inherent” it is meant the properties of the film itself, in the absence of any perforations or other alterations. It is useful to characterize the composition of a film by characterizing the gas transmission characteristics of a film that has that composition and that is 30 micrometers thick. It is contemplated that, if a film of interest were made and tested at a thickness that was different from 30 micrometers (e.g., from 20 to 40 micrometers), it would be easy for a person of ordinary skill to accurately calculate the gas transmission characteristics of a film having the same composition and having thickness of 30 micrometers. The gas transmission rate of a film having thickness 30 micrometers is labeled “GT-30” herein.

One useful inherent characteristic of a polymeric film composition is herein called “film beta ratio,” which is the quotient that is calculated by dividing the GT-30 for carbon dioxide gas transmission rate by the GT-30 for oxygen gas.

In preferred embodiments, some or all of the exterior surface of the MAP is polymeric. Preferably, the polymer is in the form of a polymeric film. Some suitable polymeric films have thickness of 5 micrometer or more; or 10 micrometer or more; or 20 micrometer or more. Independently, some suitable polymeric films have thickness of 200 micrometer or less; or 100 micrometer or less; or 50 micrometer or less.

Some suitable polymer compositions include, for example, polyolefins, polyvinyls, polystyrenes, polydienes, polysiloxanes, polyamides, vinylidene chloride polymers, vinyl chloride polymers, copolymers thereof, blends thereof, and laminations thereof. Suitable polyolefins include, for example, polyethylenes, polypropylenes, copolymers thereof, blends thereof, and laminations thereof. Suitable polyethylenes include, for example, low density polyethylene, ultralow density polyethylene, linear low density polyethylene, metallocene-catalyzed polyethylene, copolymers of ethylene with polar monomers, medium density polyethylene, high density polyethylene, copolymers thereof and blends thereof. Suitable polypropylenes include, for example, polypropylene and oriented polypropylene. In some embodiments, low density polyethylene is used. In some embodiments, copolymer of styrene and butadiene is used. Preferred are polyamides, polyolefins, and blends thereof.

Among polyolefins, preferred is polyethylene; more preferred is metallocene-catalyzed polyethylene. More preferred polymer compositions contain one or more polyolefin and one or more copolymer of an olefin monomer with a polar monomer. By “copolymer” herein is meant the product of copolymerizing two or more different monomers. Suitable copolymers of an olefin monomer with a polar monomer include, for example, such polymers available from DuPont called Elvax™ resins. Preferred are copolymers of ethylene with one or more polar monomer. Suitable polar monomers include, for example, vinyl acetate, methyl acrylate, ethyl acrylate, butyl acrylate, acrylic acid, methacrylic acid, and mixtures thereof. Preferred polar monomers contain one or more ester linkage; more preferred is vinyl acetate. Among copolymers of ethylene with one or more polar monomer, the preferred amount of polar monomer is, by weight based on the weight of the copolymer, 0.5% or more; more preferably 1% or more; more preferably 1.5% or more. Among copolymers of ethylene with one or more polar monomer, the preferred amount of polar monomer is, by weight based on the weight of the copolymer, 25% or less; more preferably 20% or less; more preferably 15% or less.

Among polyolefins, preferred are blends of a polyolefin homopolymer with a copolymer of an olefin monomer with a polar monomer. Among such blends, the preferred weight ratio of homopolymer to copolymer is 0.5:1 or higher; more preferably 0.8:1 or higher; more preferably 1:1 or higher. Among such blends, the preferred weight ratio of homopolymer to copolymer is 3:1 or lower; more preferably 2:1 or lower; more preferably 1.25:1 or lower.

Among polyamides, preferred are nylon 6, nylon 6,6, and copolymers thereof; more preferred are copolymers of nylon 6 with nylon 6,6. Among copolymers of nylon 6 with nylon 6,6 (often called nylon 666), preferred are copolymers in which the weight ratio of polymerized units of nylon 6 to polymerized units of nylon 6,6 is 0.05:1 or higher; more preferably 0.11:1 or higher; more preferably 0.25:1 or higher. Among copolymers of nylon 6 with nylon 6,6, preferred are copolymers in which the weight ratio of polymerized units of nylon 6 to polymerized units of nylon 6,6 is 9:1 or lower; more preferably 3:1 or lower; more preferably 1.5:1 or lower.

Among blends of polyamide with polyolefin, preferred are blends in which the weight ratio of polyamide to polyolefin is 0.05:1 or higher; more preferably 0.11:1 or higher; more preferably 0.25:1 or higher; more preferably 0.5:1 or higher. Among blends of polyamide with polyolefin, preferred are blends in which the weight ratio of polyamide to polyolefin is 9:1 or lower; more preferably 5:1 or lower; more preferably 3:1 or lower.

When it is stated herein that a container comprises polymeric film, it is meant that some or all of the surface area of the container consists of polymeric film, and the film is arranged so that molecules that are capable of diffusing through the polymeric film will diffuse between the inside of the container and the outside of the container in both directions. Such a container may be constructed so that one, two, or more separate portions of the surface area of the container consist of polymeric film, and the polymeric film portions may be the same composition as each other or may be different from each other. It is contemplated that such containers will be constructed so that the portion of the container surface that is not polymeric film will effectively block diffusion of gas molecules (i.e., the amount of gas molecules that diffuse through will be of negligible importance).

Among polyolefin films, the following are preferred film compositions. Preferred are film compositions for which the GT-30 for carbon dioxide at 23° C., in units of cm³/(m²-day), is 800 or higher; more preferred is 4,000 or higher; more preferred is 5,000 or higher; more preferred is 10,000 or higher; more preferred is 20,000 or higher. Preferred are films with GT-30 for carbon dioxide at 23° C., in units of cm³/(m²-day), of 150,000 or lower; more preferred is 80,000 or lower; more preferred is 60,000 or lower. Preferred are films with GT-30 for oxygen at 23° C., in units of cm³/(m²-day), of 200 or higher; more preferred is 1,000 or higher; more preferred is 3,000 or higher; more preferred is 6,000 or higher. Preferred are films with GT-30 for oxygen at 23° C., in units of cm³/(m²-day), of 150,000 or lower; more preferred is 80,000 or lower; more preferred is 40,000 or lower; more preferred is 20,000 or lower; more preferred is 15,000 or lower. Preferred are films with GT-30 for water vapor at 37.8° C., in units of g/(m²-day), of 5 or higher; more preferred is 10 or higher. Preferred are films with GT-30 for water vapor at 37.8° C., in units of g/(m²-day), of 330 or lower; more preferred is 150 or lower; more preferred is 100 or lower; more preferred is 55 or lower; more preferred is 45 or lower; more preferred is 35 or lower. Preferred film has film beta ratio of 1 or higher; more preferred is 2 or higher. Preferred film has beta ratio of 15 or lower; more preferred is 10 or lower.

Polyamide films, as used herein, includes films containing polyamide and films containing a blend of polyamide with one or more other polymer. Among polyamide films, the following are preferred film compositions. Preferred are films with GT-30 for water vapor at 37.8° C., in units of g/(m²-day), of 10 or higher; more preferred is 20 or higher. Preferred are films with GT-30 for water vapor at 37.8° C., in units of g/(m²-day), of 1,000 or lower; more preferred is 800 or lower; more preferred is 500 or lower; more preferred is 350 or lower; more preferred is 200 or lower.

It is contemplated that the GT-30 for oxygen and the GT-30 for carbon dioxide are both very low for polyamide films. It is contemplated that when MAP is used that is made of a film that is made of polyamide or a blend of polyamide with other polymer(s), the film will be perforated in a way that is chosen to provide the desired gas transmission characteristics of the MAP itself.

In one embodiment, polymeric film is used that has perforations. In preferred such embodiments, the holes have mean diameter of 5 micrometers to 500 micrometers. In preferred embodiments involving perforations, the holes have mean diameter of 10 micrometers or more; more preferably 20 micrometers or more; more preferably 50 micrometers or more; more preferably 100 micrometers or more. Independently, in preferred embodiments involving perforations, the holes have mean diameter 300 micrometers or less; more preferably 200 micrometers or less. If a hole is not circular, the diameter of the hole is considered herein to be 2 times the square root of the quotient of the area of the hole divided by pi.

In one embodiment, the MAP comprises polymeric film, and the percent of the surface area of the MAP that consists of the polymeric film is 10% to 100%; more preferably 50% to 100%; more preferably 75% to 100%; more preferably 90% to 100%. An MAP in which 90% to 100% of the surface area consists of polymeric film is known herein as a “bag.” Preferred are MAP that comprise polymeric film and in which all portions of the surface of the MAP that are not polymeric film effectively block diffusion of gas molecules. In embodiments in which the MAP comprises polymeric film and the remainder (if any) of the surface of the MAP effectively blocks diffusion of gas molecules, the MAP is considered to be passive MAP.

Holes in polymeric film may be made by any method. Suitable methods include, for example, laser perforation, hot needles, flame, low-energy electrical discharge, and high-energy electrical discharge. In one embodiment, such method is laser perforation.

Another useful way to characterize an MAP is the “MAP beta ratio,” which is defined herein as the quotient that results from dividing the rate of transmission of carbon dioxide of the MAP by the rate of transmission of oxygen of the MAP itself. Preferably, the MAP beta ratio is 0.3 or higher; more preferably 0.5 or higher. Preferably, the MAP beta ratio is 5 or lower; more preferably 3 or lower; more preferably 2 or lower. Preferably, when the MAP is made entirely of polyolefin film, the MAP beta ratio is 1.0 to 1.6. Preferably, when the MAP is made entirely of polyamide film, the MAP beta ratio is 0.5 to 0.999. Preferably, when the MAP is made of a film that contains a blend of polyamide and polyolefin, the MAP beta ratio is 0.6 to 1.2.

The avocados used in the practice of the present invention may be any cultivar. Preferred cultivars are Choquette, Hass, Gwen, Lula, Pinkerton, Reed, Bacon, Brogden, Ettinger, Fuerte, Monroe, Sharwil, and Zutano.

In one embodiment, avocados are harvested when they are mature but not yet ripe. In another embodiment, the avocados are harvested when the dry matter content, by weight based on the weight of the avocados, is 17% or higher.

In some embodiments, avocados are harvested and immediately placed into MAP. Among such embodiments, the time from harvest to placement into MAP is preferably 30 days or less; more preferably 14 days or less, more preferably 7 days or less, more preferably 2 days or less. In some embodiments, harvested avocados are placed into MAP prior to shipment, and the harvested avocados remain in the MAP during shipment.

In some embodiments, avocados are harvested and, prior to being placed into MAP, the avocados are placed in pre-shipment storage. Such pre-shipment storage may be below room temperature, for example 7° C. or lower. After such storage, the avocados may be placed in to MAP and then shipped to their destination.

In another embodiment, avocados are shipped to a destination that is near the intended point of consumption or else are harvested near the intended point of consumption and/or sale. As used herein, “near the intended point of consumption and/or sale” means a location from which it is capable to transport the avocados to the point of consumption in 3 days or fewer by truck or other surface transportation.

In another embodiment, Avocados are exposed to an atmosphere that contains a cyclopropene compound when the avocados have pulp firmness of 65 to 150 N (15 to 34 lbf). Avocados are preferably exposed to an atmosphere that contains a cyclopropene compound when the avocados have pulp firmness of 65 N (15 lbf) or higher; more preferably, 70 N (16 lbf) or higher; more preferably 80 N (18 lbf) or higher. Avocados are preferably exposed to an atmosphere that contains a cyclopropene compound when the avocados have pulp firmness of 150 N (34 lbf) or lower; preferably, 140 N (32 lbf) or lower; more preferably 130 N (29 lbf) or lower; more preferably 120 N (27 lbf) or lower.

In some embodiments, avocados are exposed to an atmosphere that contains a cyclopropene compound while the avocados are not in an MAP. In such embodiments, avocados are placed into an MAP after the conclusion of the exposure to the atmosphere that contains a cyclopropene compound, and the avocados then remain in the MAP for at least two hours.

In another embodiment where avocados are placed into a modified-atmosphere package after exposure to the cyclopropene compound, the avocados are kept at temperature of 10° C. or above from the conclusion of the exposure to the atmosphere that contains a cyclopropene compound until the avocados are placed into the MAP. In another embodiment where avocados are placed into a modified-atmosphere package after exposure to the cyclopropene compound, the time period from the conclusion of the exposure to the atmosphere that contains a cyclopropene compound until the avocados are placed into the MAP is 8 hours or less; 4 hours or less; 2 hours or less; or 1 hour or less.

In another embodiment where avocados are placed into a modified-atmosphere package after exposure to the cyclopropene compound, the avocados are kept at temperature below 10° C. from the conclusion of the exposure to the atmosphere that contains a cyclopropene compound until the avocados are placed into the MAP. In another embodiment where avocados are placed into a modified-atmosphere package after exposure to the cyclopropene compound, the temperature at which avocados are kept from the conclusion of the exposure to the atmosphere that contains a cyclopropene compound until the avocados are placed into the MAP is preferably 7° C. or lower. In another further embodiment, the time period from the conclusion of the exposure to the atmosphere that contains a cyclopropene compound until the avocados are placed into the MAP may be between ten minutes and two months.

In one embodiment where the avocados are in a modified-atmosphere package during exposure to the cyclopropene compound (for example, avocados are exposed to an atmosphere that contains a cyclopropene compound while the avocados are in a MAP), there is an improvement in the pulp firmness of the avocadoes that can be seen even immediately after the conclusion of the exposure of the avocadoes to the cyclopropene compound.

In another embodiment where the avocados are in a modified-atmosphere package during exposure to the cyclopropene compound, avocados are in an MAP for a time period of duration of 1 day or more, where that time period is after harvest and before exposure to atmosphere containing a cyclopropene compound (herein called a “pre-X” time period). In a further embodiment, composition of the MAP comprises polyamide.

In some embodiments, the avocados reside in an MAP for a storage time period that begins within 1 hour of the conclusion of the exposure to atmosphere containing cyclopropene compound (herein called a “post-X” time period). For example, post-X storage time period may begin within thirty minutes of the conclusion of the exposure to cyclopropene compound; within fifteen minutes; within eight minutes; or within one minute.

In another embodiment where the avocados are in a modified-atmosphere package during exposure to the cyclopropene compound, the avocados are in an MAP during exposure to atmosphere containing cyclopropene compound; if the avocados remain in the MAP thereafter without being removed from the MAP, the post-X storage time period is considered to begin immediately upon the conclusion of the exposure to atmosphere containing cyclopropene compound. For example, the post-X storage time period may last for one day or longer; or 2 days or longer.

By “conclusion of exposing the avocados to a cyclopropene compound,” it is meant herein a time after which avocados have been exposed to a cyclopropene compound as described herein and at which the concentration of cyclopropene compound in the atmosphere around the avocados (or the atmosphere around the permeable surrounding device, if the avocados were in a permeable surrounding device during exposure to cyclopropene compound) falls below 0.5 ppb.

It is contemplated that any (b) embodiment may be combined with any of the preferred embodiments described herein. It is also contemplated that, independently, any (a) embodiment may be combined with any of the preferred embodiments described herein.

In some embodiments, suitable MAP is chosen or designed so that, when avocados are placed into the MAP and the MAP, with the avocados inside, is then exposed to atmosphere containing cyclopropene compound, and then stored for 10 days at 16.7° C., a certain pre-determined atmosphere will be present in the MAP. In one embodiment with the pre-determined atmosphere, the amount of carbon dioxide, by volume based on the volume of the atmosphere inside the MAP, may be 1% or more; or 5% or more. In another embodiment with the pre-determined atmosphere, the amount of carbon dioxide, by volume based on the volume of the atmosphere inside the MAP, may be 20% or less; or 15% or less. In another embodiment with the pre-determined atmosphere, the amount of oxygen, by volume based on the volume of the atmosphere inside the MAP, may be 3% or more; or 5% or more. In another embodiment with the pre-determined atmosphere, the amount of oxygen, by volume based on the volume of the atmosphere inside the MAP, may be 20% or less; or 15% or less.

The Oxygen Transmission Rate or OTR for a modified atmosphere package can be calculated from the work presented in literature or measured directly. For a microperforated polymer bag the OTR due to the permeability of the film at any given time can be theoretically calculated using Fick's law of diffusion where the permeability coefficient for the polymer film can be measured using a procedure as called out in ASTM method D3985 for O₂. For this same microperforated bag the OTR due to the microperforations can be calculated using a modified Fick's law of diffusion. The OTR at any given time is dependent on the O₂ concentration driving force at that point of time. The OTR of the system can be measured by measuring the O₂ partial pressure versus time and then plotting the natural log of the concentration gradient versus time. This is a convenient method in cases where there are not well validated models for the OTR such as microporous systems or unique combinations of approaches such as microporous patches combined with films or microperforated films.

### EXAMPLES

The materials used in the following Examples were these:
EVA1=ELVAX™ 3124 resin (DuPont Co.), Ethylene/Vinyl Acetate resin with 9% vinyl acetate by weight, based on the weight of the EVA, with melt index (ASTM D1238 190° C./2.16 kg) of 7 g/10 minute.
m-LLDPE=EXCEED™ 1018 resin (Exxon-Mobil Co.), metallocene Linear Low Density Polyethylene with a melt index (ASTM D1238, 190° C./2.16 kg) of 1.0 g/10 minutes and with density (ASTM D792) of 0.918 g/cm³.
Slip A=diatomaceous earth (15% by weight based on the weight of Slip A) in polyethylene.
Slip B=stearamide (10% by weight based on the weight of Slip B) in ethylene/vinyl acetate copolymer.
Slip-AB=Mixture of Slip A and Slip B, with weight ratio of Slip A to Slip B of 3.0 to 2.5.
ELITE™ 5400G=Enhanced Polyethylene resin (metallocene polyethylene) available from The Dow Chemical Company with a melt index (ASTM D1238 190 C/2.16 kg) of 1.0 g/10 minutes, a density (ASTM D792) of 0.916 g/cm3;
CN 734=an antiblock containing masterbatch available from several different vendors with targeted amount of 15% diatomaceous earth by weight in 85% polyethylene.
CN 706=a stearamide (slip) containing masterbatch available from several different vendors with targeted amount of 10% by weight in 90% ethylene vinyl acetate co-polymer.
ELVAX 3170=ethylene-vinyl acetate copolymer available from Dupont Polymers with a melt index (ASTM D1238 190 C/2.16 kg) of 2.5 g/10 minutes and 18 wt % vinyl acetate.
10090=masterbatch available from Ampacet which contains 5% slip in an 8 MI LDPE base resin
10063=masterbatch also available from Ampacet which contains 20% diatomaceous earth in an 8 MI LDPE base resin.
SAB=Additive for slip and/or anti-block, containing one or more of Slip A, Slip B, 10090, and 10063.
m-PE=either m-LLDPE or ELITE™ 5400G
MCP=1-methylcyclopropene

The MAP bags used in the following Examples were made by producing film, then perforating that film, then making bags from the perforated film. The film was a three-layer coextrudate that was blown to produce film of thickness 29.5 micrometer (1.16 mil). The volume ratio of the layers was this:

first layer/second layer/third layer=30/40/30.

Each layer was a blend of EVA, m-LLDPE, and, optionally, SAB. The approximate weight ratios were as follows:
first layer: EVA1/m-PE/SAB=45/51/4
second layer: EVA1/m-PE/SAB=46/54/0
third layer: EVA1/m-PE/SAB=45/50/5

The film was perforated using a beam compression laser processing system to give average hole diameter of 105 micrometer. Film was folded to form rectangles of 48 cm by 30 cm (18.75 inch by 12 inch) and sealed on three sides to form bags. Each bag had 88 holes.

Avocado skin color was rated using the following scale:
1=full green
2=green with traces of brown
3=half green and half brown
4=brown with traces of green
5=purple-black

Pulp firmness was evaluated by peeling open 4 cm² of the avocado's peel using a fruit peeler provided with the penetrometer. The penetrometer was mounted on a manual stand with a lever to deliver uniform force throughout the test. The avocado was placed with the peeled surface beneath the penetrometer tip with probe diameter of 8 mm, and the force required to punch through the pulp was measured. Each fruit was tested in 3 places.

### Example 1

### Avocados from California, USA

Avocados were harvested in Oxnard, Calif., USA and packed in cardboard boxes and shipped to Sacramento, Calif., USA. After 2 days of transportation part of the avocados were packed in MAP bags. The appropriate weight of avocados was placed in each bag after harvest and shipment. Bags were placed in RPC (Recycle Plastic Container) carrying devices. Avocados then were stored at room temperature (22° C.).

The Test Protocol that was used was as follows. 60 MAP bags were packed. Each bag held approximately 1.7 kg (3.8 lb) of avocados. Three such bags were packed in each RPC. Total weight of avocados in MAP bags was approximately 102 kg. Approximately 51 kg of avocados were placed into RPC identical to those used for the MAP bags. The MAP-packaged avocados were packaged as follows: Nine fruits, approximately 1.7 kg (3.8 lb) were carefully placed into MAP bags, and the bags were sealed by twisting the open side of the bag, folding down the twisted end, and placing a rubber band around the twisted and folded end of the bag. Fruits that did not receive MAP treatment (labeled “no-MAP” below) were placed in the same type of bags, but the bags were left open to the atmosphere, and so those bags did not act as modified-atmosphere packaging.

Avocados were harvested with a very high firmness (not possible to measure with FTA Machines (Firmness Texture Analyzer)). The FTA higher limit was 156 N (35 lbf). To monitor the ripening process of the avocados, extra fruits were bagged in MAP bags and the firmness was monitored every day, twice a day until the fruits achieve an average firmness of 111 N (25 lbf). All avocados were kept at room temperature (22° C.) until achieving an average firmness of 111 N (25 lbf).

Bags were not opened until the day of the evaluation. Temperature was monitored in some of the RPCs by placing a temperature monitor inside of the container.

After achieving an average firmness of 111 N (25 lbf) the avocados were randomly divided into treatment sets as follows:

MCP Concentration

| Bag Type | 0 ppb | 300 ppb | 600 ppb | 900 ppb |
|---|---|---|---|---|
| No MAP | 5 RPCs | none | 5 RPCs | none |
| MAP Bag | 5 RPCs | 5 RPCs | 5 RPCs | 5 RPCs |

The treatment group with MAP bags and with non-zero MCP are examples of the present invention. All other treatment groups are comparative. Avocados that received no MAP and no MCP are herein called “untreated control” avocados.

Skin Color ratings

| | | Day | | | | |
|---|---|---|---|---|---|---|
| Bag | ppb of MCP | 0 | 1 | 2 | 3 | 4 |
| No Bag | 0 | 3.4 | 4.5 | 4.9 | 5.2 | 4.6 |
| No Bag | 600 | 2.6 | 3.0 | 2.8 | 3.8 | 3.4 |
| MAP | 0 | 2.2 | 2.7 | 2.8 | 3.9 | 3.6 |
| MAP | 300 | 1.7 | 2.9 | 2.3 | 2.8 | 2.3 |
| MAP | 600 | 1.7 | 2.3 | 2.3 | 2.2 | 2.1 |
| MAP | 900 | 1.6 | 2.3 | 2.3 | 2.3 | 2.4 |

On the same day the avocados achieved 111 N (25 lbf) of average firmness, each treatment set was marked, placed in a hermetical chamber at room temperature (22° C.). All chambers were of equal size and packed the same way. Treatment was for 12 hr. In the chambers for the 3 “MCP” treatment groups, at the beginning of the treatment period, SmartFresh™ SmartTabs™ tablets (AgroFresh, Inc.) were placed in the chamber. The amount of SmartFresh™ SmartTabs™ tablets was chosen to achieve the indicated concentration of 1-methylcyclopropene in the atmosphere of the chamber. The SmartTabs™ tablets were contacted with water in the normal way to release 1-MCP.

Pulp Firmness (Ns (lbf))

| | | Day | | | | |
|---|---|---|---|---|---|---|
| Bag | ppb of MCP | 0 | 1 | 2 | 3 | 4 |
| No Bag | 0 | 27 (6.0) | 19 (4.2) | 15 (3.3) | 6.7 (1.5) | 12 (2.7) |
| No Bag | 600 | 56 (12.6) | 33 (7.4) | 25 (5.6) | 24 (5.3) | 24 (5.3) |
| MAP | 0 | 95 (21.4) | 36 (8.1) | 25 (5.5) | 10 (2.3) | 8.0 (1.8) |
| MAP | 300 | 117 (26.3) | 41 (9.3) | 51 (11.5) | 48 (10.8) | 45 (10.2) |
| MAP | 600 | 111 (24.9) | 65 (14.6) | 54 (12.1) | 66 (14.8) | 52 (11.8) |
| MAP | 900 | 120 (26.9) | 80 (18.0) | 67 (15.0) | 56 (12.6) | 58 (13.0) |

After the treatment in the chambers, the RPCs were moved into racks at room temperature for storage and observation. Avocados remained in the same bags throughout the packing, treatment in the chamber, and subsequent storage. Evaluation for skin color and pulp firmness was as follows. Day “zero” was the day the avocados were removed from the chamber and placed in storage. Each test result was the average of 12 fruits.

The results above show that the avocados treated by the method of the present invention have skin browning delayed and pulp firmness retention for a longer period of time than any other treatment.

The effect of the combination of MCP and MAP on firmness can be seen by re-presenting the above data, showing the difference between each treatment group and the corresponding untreated control, as follows:

Pulp Firmness -- Difference from Untreated Control (Ns)

| | | Day | | | | |
|---|---|---|---|---|---|---|
| Bag | ppb of MCP | 0 | 1 | 2 | 3 | 4 |
| No Bag | 0 | 0 | 0 | 0 | 0 | 0 |
| No Bag | 600 | 29 | 14 | 10 | 17.3 | 12 |
| MAP | 0 | 68 | 17 | 10 | 3.3 | −4 |
| MAP | 300 | 90 | 22 | 36 | 41.3 | 33 |
| MAP | 600 | 84 | 46 | 39 | 59.3 | 40 |
| MAP | 900 | 93 | 61 | 52 | 49.3 | 46 |

The effect of the combination of MCP and MAP appears to be synergistic. For example, on day 3, MCP alone at 600 ppb gives an improvement over the untreated control of 17.3 N (4 lbf), and the MAP alone gives an improvement over the untreated control of 3.3 N (0.7 lbf). An additive combination of these two improvements would be 20.6 N (5 lbf), and every combination of MAP and MCP gives an improvement of more than 40 N (9 lbf).

### Example 2

### Avocados from Mexico—Treatment at 71 N (16 lbf)

Avocados were harvested in Mexico and shipped to Pennsylvania, USA. 48 fruits were tested. When the fruits reached pulp firmness of 71 N (16 lbf), half of the fruits were exposed to atmosphere having 1000 ppb of MCP at 21.1° C. for 12 hours and half were not. Immediately after treatment, fruits were placed in MAP bags. The number of fruits per bag was either 1, 2, 3, 4, or 10. Two MCP-treated fruits were left out of any MAP, and two fruits not exposed to MCP were also left out of any MAP. All fruits were then stored at 21° C. (70° F.). On the eighth day after exposure to atmosphere containing MCP, fruits were tested with the following results. The results shown are the averages for all the fruits tested in each category.

Pulp Firmness (Newtons (lbf)) on Day 8

| Bag | MCP | Firmness | Difference⁽¹⁾ |
|---|---|---|---|
| none | 0 | 12.9 (2.9) | 0 |
| none | 1000 ppb | 16.8 (3.8) | 3.9 (0.9) |
| MAP | 0 | 16.7 (3.8) | 3.8 (0.9) |
| MAP | 1000 ppb | 25.5 (5.7) | 12.6 (2.8) |

Note
⁽¹⁾Difference in firmness between the sample shown and the sample with no MCP and no MAP (Newtons). The effect of combining MAP with MCP appears to be synergistic.

### Example 3

### Avocados from Mexico—Treatment at 98 N (22 lbf)

Avocados were harvested and shipped as in Example 2. Treatment was performed when pulp firmness reached 98 N (22 lbf). 50 fruits were tested. Otherwise the treatment and handling was the same as in Example 2. Results (average of all fruits tested in each category) were as follows:

Pulp Firmness (Newtons (lbf)) on Day 8

| Bag | MCP | Firmness | Difference⁽¹⁾ |
|---|---|---|---|
| none | 0 | 12.02 (2.7) | 0 |
| none | 1000 ppb | 16.91 (3.8) | 4.9 (1) |
| MAP | 0 | 12.02 (2.7) | 0 (0) |
| MAP | 1000 ppb | 37.83 (8.5) | 25.81 (5.8) |

Skin Color on Day 8

| Bag | MCP | Color Rating | Difference⁽²⁾ |
|---|---|---|---|
| none | 0 | 5 | 0 |
| none | 1000 ppb | 5 | 0 |
| MAP | 0 | 4.6 | 0.4 |
| MAP | 1000 ppb | 4.2 | 0.2 |

Note (1): Difference in firmness between the sample shown and the sample with no MCP and no MAP (Newtons (lbf)). Note (2): Difference in Color Rating between the sample shown and the sample with no MCP and no MAP (Newtons). The combination of MAP with MCP appears to be synergistic for both skin color and pulp firmness.

### Example 4

### Results as a Function of Fruit Per Container—Polyethylene

Two different types of containers were used. One type was the MAP bag described herein above. The number of fruits per bag was either 1, 2, 3, 4, or 10.

The other type was a 4 liter glass jar with mouth opening having radius of 12 cm (4.75 inch). After fruit were placed into a jar, a flat section of the perforated film from an MAP bag was stretched flat across the mouth of the jar and fixed in place with epoxy resin. The number of fruits per bag was either 1, 2, 3, 4, or 5.

Fruit were weighed prior to placing them into each container. Containers were exposed to atmosphere having 1,000 ppb of 1-MCP for 12 hours at 21.1° C. (70° F.). Containers were then held in a normal atmosphere at 21.1° C. (70° F.) for 8 days. Then the concentration of oxygen and carbon dioxide (% by weight, generated based on the fruit weight) was measured in the headspace of each container, and the fruit quality in each container was evaluated. The inherent characteristics of the perforated film were known, and so, for each container, it was possible to determine the oxygen transmission rate and the carbon dioxide transmission rate. Results were as follows:

Container Characteristics

| | | Fruits per | weight of | | |
|---|---|---|---|---|---|
| Number | Container | container | fruits (g) | OTR⁽¹⁾ | CO2TR⁽²⁾ |
| 4-1 | bag | 1 | 215 | 71,800 | 96,000 |
| 4-2 | bag | 2 | 444.5 | 34,700 | 46,400 |
| 4-3 | bag | 3 | 670 | 23,000 | 30,800 |
| 4-4 | bag | 4 | 888.5 | 17,400 | 23,200 |
| 4-5 | bag | 10 | 2100 | 7,300 | 9,800 |
| 4-6 | jar | 1 | 215 | 16,100 | 21,000 |
| 4-7 | jar | 2 | 446.4 | 7,800 | 10,100 |
| 4-8 | jar | 3 | 674 | 5,100 | 6,700 |
| 4-9 | jar | 4 | 902 | 3,800 | 5,000 |
| 4-10 | jar | 5 | 1070 | 3,200 | 4,200 |

Note
⁽¹⁾Oxygen transmission rate for the container (cubic centimeters per day per kilogram of avocados).
Note
⁽²⁾Carbon Dioxide transmission rate for the container (cubic centimeters per day per kilogram of avocados).

Results on Day 8

| Number | O₂ (%) | CO₂ (%) | fruit quality |
|---|---|---|---|
| 5-1 | 19.6 | 1.2 | |
| 5-2 | 16.8 | 3.6 | |
| 5-3 | 14.7 | 5.5 | |
| 5-4 | 13.6 | 6.3 | |
| 5-5 | 6.8 | 12.4 | excellent |
| 5-6 | 14.2 | 7.2 | |
| 5-7 | 7.1 | 13.8 | excellent |
| 5-8 | 4.6 | 16 | |
| 5-9 | 3.1 | 18.4 | acceptable |
| 5-10 | 2 | 19.5 | bad |

### Example 5

### Expected Results Using Polyamide MAP

It is contemplated that Example 4 could be repeated using perforated polyamide instead of perforated polyolefin.

Expected Container Characteristics

| | | Fruits per | weight of | | |
|---|---|---|---|---|---|
| Number | Container | container | fruits (g) | OTR⁽¹⁾ | CO2TR⁽²⁾ |
| 5-1 | bag | 1 | 215 | 61,400 | 46,700 |
| 5-2 | bag | 2 | 444.5 | 29,700 | 22,600 |
| 5-3 | bag | 3 | 670 | 19,700 | 15,000 |
| 5-4 | bag | 4 | 888.5 | 14,900 | 11,300 |
| 5-5 | bag | 10 | 2100 | 6,300 | 4,800 |
| 5-6 | jar | 1 | 215 | 14,000 | 10,700 |
| 5-7 | jar | 2 | 446.4 | 6,700 | 5,100 |
| 5-8 | jar | 3 | 674 | 4,500 | 3,400 |
| 5-9 | jar | 4 | 902 | 3,300 | 2,500 |
| 5-10 | jar | 5 | 1070 | 2,800 | 2,100 |

Note
⁽¹⁾Oxygen transmission rate for the container (cubic centimeters per day per kilogram of avocados).
Note
⁽²⁾Carbon Dioxide transmission rate for the container (cubic centimeters per day per kilogram of avocados).

Expected Results on Day 8

| Number | fruit quality |
|---|---|
| 5-1 | acceptable or better |
| 5-2 | acceptable or better |
| 5-3 | acceptable or better |
| 5-4 | acceptable or better |
| 5-5 | acceptable or better |
| 5-6 | acceptable or better |
| 5-7 | acceptable or better |
| 5-8 | acceptable or better |
| 5-9 | bad |
| 5-10 | bad |

It is contemplated that the perforated polyamide would be designed to give desirable rate of transmission of water vapor. Based on typical characteristics of polyamide film, the following bag characteristics and results would be expected.

### Example 6

### Ethylene-Treated Fruit

Avocados were harvested, handled, and tested as in Example 1. Fruits were placed into MAP bags or else into “Poly bags” (plastic bags having more than 10 holes per bag, with each hole larger than 1 cm in diameter).

Skin Color ratings

| | | Day | | | | |
|---|---|---|---|---|---|---|
| Bag | ppb of MCP | 0 | 1 | 2 | 3 | 4 |
| MAP | 0 | 1.9 | 3.5 | 3.8 | 4.0 | 4.3 |
| MAP | 900 | 2.1 | 3.0 | 3.3 | 3.4 | 4.4 |
| Poly | 0 | 4.8 | 5.6 | 5.5 | 5.3 | 6.0 |
| Poly | 900 | 4.1 | 4.9 | 4.8 | 4.8 | 4.9 |

Pulp Firmness (Ns (lbf))

| | | Day | | | | |
|---|---|---|---|---|---|---|
| Bag | ppb MCP | 0 | 1 | 2 | 3 | 4 |
| MAP | 0 | 18.7 (4.2) | 27.1 (6.1) | 16.51 (3.7) | 17.6 (4.0) | 7.0 (1.6) |
| MAP | 900 | 16.9 (3.8) | 35.8 (8.0) | 19.0 (4.3) | 27.7 (6.2) | 18.4 (4.1) |
| Poly | 0 | 3.1 (0.7) | 5.4 (1.2) | 4.4 (1.0) | 6.2 (1.4) | 3.5 (0.8) |
| Poly | 900 | 3.2 (0/7) | 6.5 (1.5) | 5.0 (1.1) | 7.6 (1.7) | 3.6 (0.8) |

It is considered that the holes in the poly bags are sufficiently large and numerous that the poly bags do not serve as modified-atmosphere packaging. Three fruits (approximately 1.8 kg of fruit) were placed in each bag. After placement into bags, fruit was exposed to ethylene (200 ppm for 24 hours at 22° C.). Then, the fruit was exposed to 1-MCP (900 ppb for 15 hours at 22° C.).

In skin color, the examples of the present invention (MAP bags and 900 ppb of 1-MCP), had the best skin color on days 1, 2, and 3. In pulp firmness, the examples of the present invention (MAP bags and 900 ppb of 1-MCP), had the best pulp firmness on days 1-4. The same data on pulp firmness can be presented by calculating the difference on each day between each sample and the control sample (Poly bag, 0 MCP). The results are shown below.

The examples of the present invention (MAP bags and 900 ppb 1-MCP) show that the combination of MAP bag and the use of 1-MCP brings a synergistic benefit to pulp firmness on days 1-4.

Pulp Firmness Difference from the Control Sample (Ns)

Day

| Bag | ppb MCP | 0 | 1 | 2 | 3 | 4 |
|---|---|---|---|---|---|---|
| MAP | 0 | 15.5 | 21.6 | 12.1 | 11.4 | 3.5 |
| MAP | 900 | 13.8 | 30.4 | 14.6 | 21.4 | 14.8 |
| Poly | 0 | 0 | 0 | 0 | 0 | 0 |
| Poly | 900 | 0.1 | 1.1 | 0.6 | 1.4 | 0.1 |

### Example 7

### RipeLock Applications

Avocados are harvested, handled, and tested as in previous examples. Control samples have no bag and no SmartFresh (1-methylcyclopropene or 1-MCP) application. SmartFresh samples have no bags but with 600 ppb SmartFresh (1-methylcyclopropene or 1-MCP) application. MAP samples use the 3 lb MAP bags but no SmartFresh (1-methylcyclopropene or 1-MCP) application. RipeLock 300 samples have the 3 lb MAP bags with 300 ppb SmartFresh (1-methylcyclopropene or 1-MCP) application. RipeLock 600 samples have the 3 lb MAP bags with 600 ppb SmartFresh (1-methylcyclopropene or 1-MCP) application. RipeLock 900 samples have the 3 lb MAP bags with 900 ppb SmartFresh (1-methylcyclopropene or 1-MCP) application. Average fruit in each sample is about 3.8 lb.

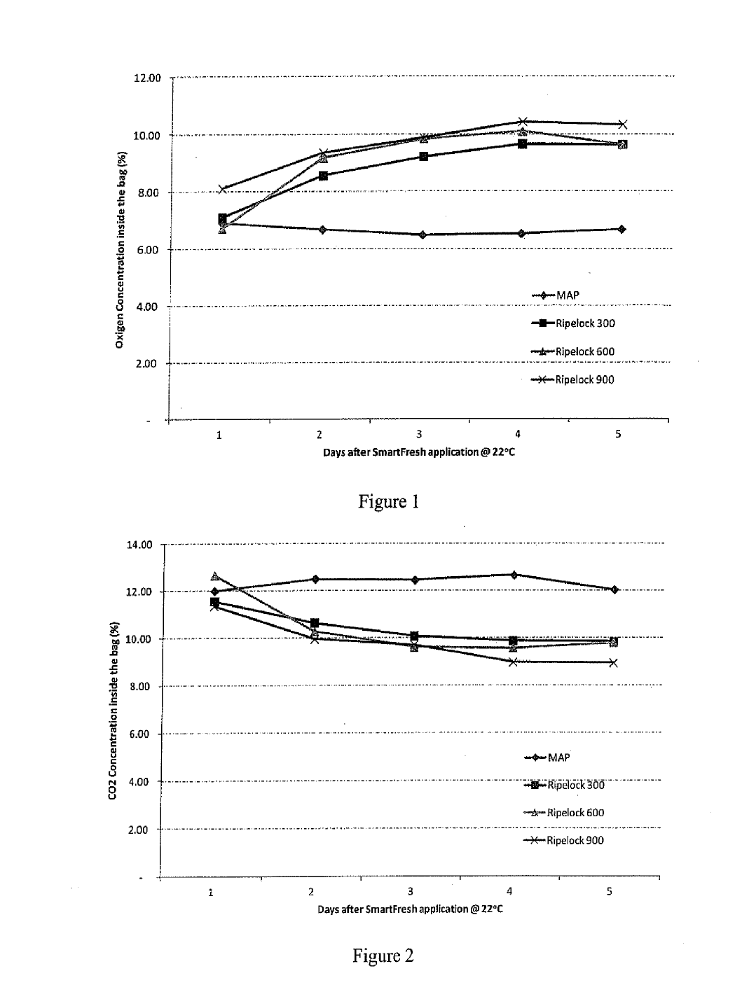

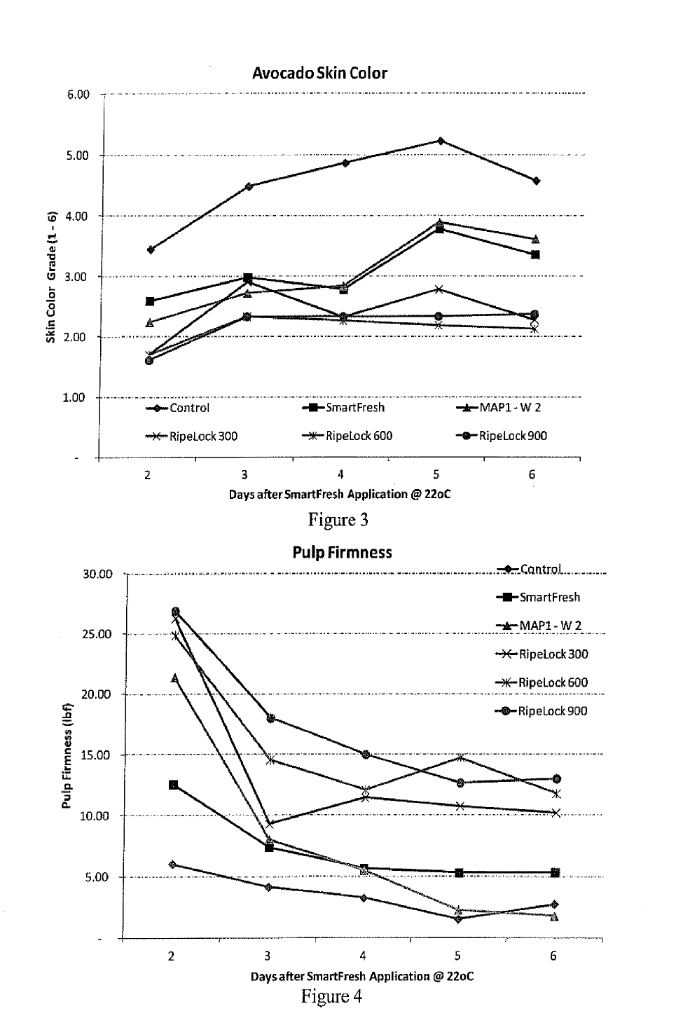

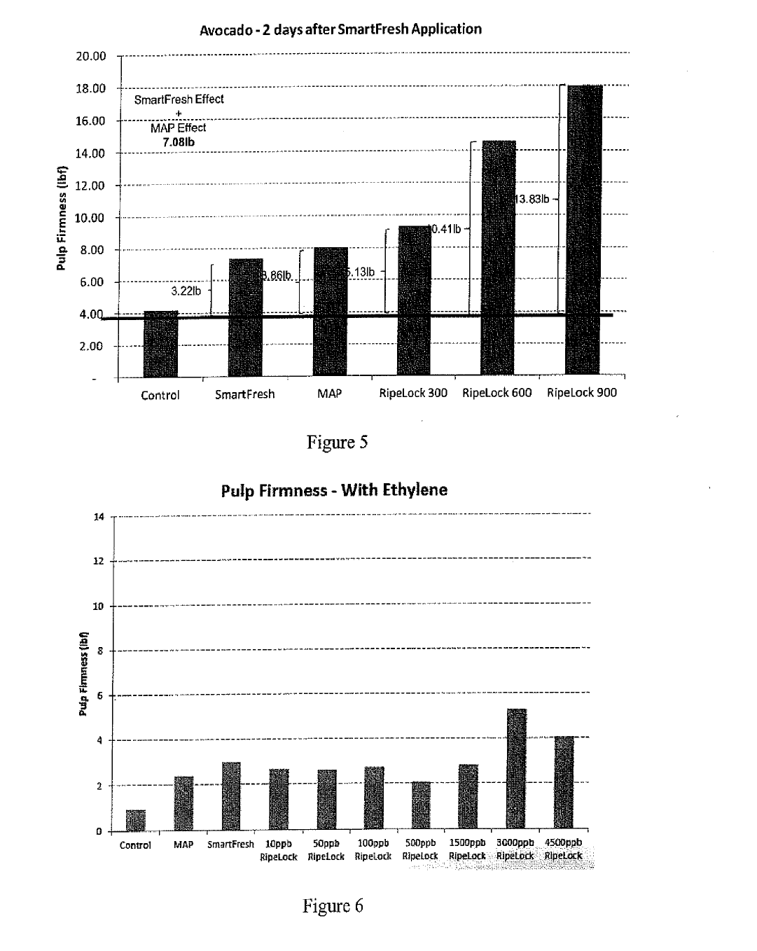

Oxygen (O₂) concentrations of samples tested are shown in FIG. 1, and carbon dioxide (CO₂) concentrations of samples tested are shown in FIG. 2. Skin colors of avocados tested are shown in FIG. 3, and data of pulp firmness of avocado tested are shown in FIG. 4. The results show synergistic effect for MAP bags and SmartFresh (1-methylcyclopropene or 1-MCP) application as shown in FIG. 5. The RipeLock applications (combination of MAP bag and 1-MCP application) can keep the fruits firm and green for a longer period of time (i.e., longer shelf-life) than previous methods.

### Example 8

### Additional RipeLock Applications

Avocados are harvested, handled, and tested as in previous examples. Control samples have no bag and no SmartFresh (1-methylcyclopropene or 1-MCP) application. SmartFresh samples have no bags but with 500 ppb SmartFresh (1-methylcyclopropene or 1-MCP) application. MAP samples use the 3 lb MAP bags but no SmartFresh (1-methylcyclopropene or 1-MCP) application. RipeLock samples have the 3 lb MAP bags with various concentrations of SmartFresh (1-methylcyclopropene or 1-MCP) applications, including 10 ppb, 50 ppb, 100 ppb, 500 ppb, 1500 ppb, 3000 ppb, and 4500 ppb. Average fruit in each sample is about 3.8 lb. Ethylene is treated after packing at 200 ppm for twenty-four hours. Evaluations are performed seven days at 22° C. after SmartFresh (1-methylcyclopropene or 1-MCP) applications.

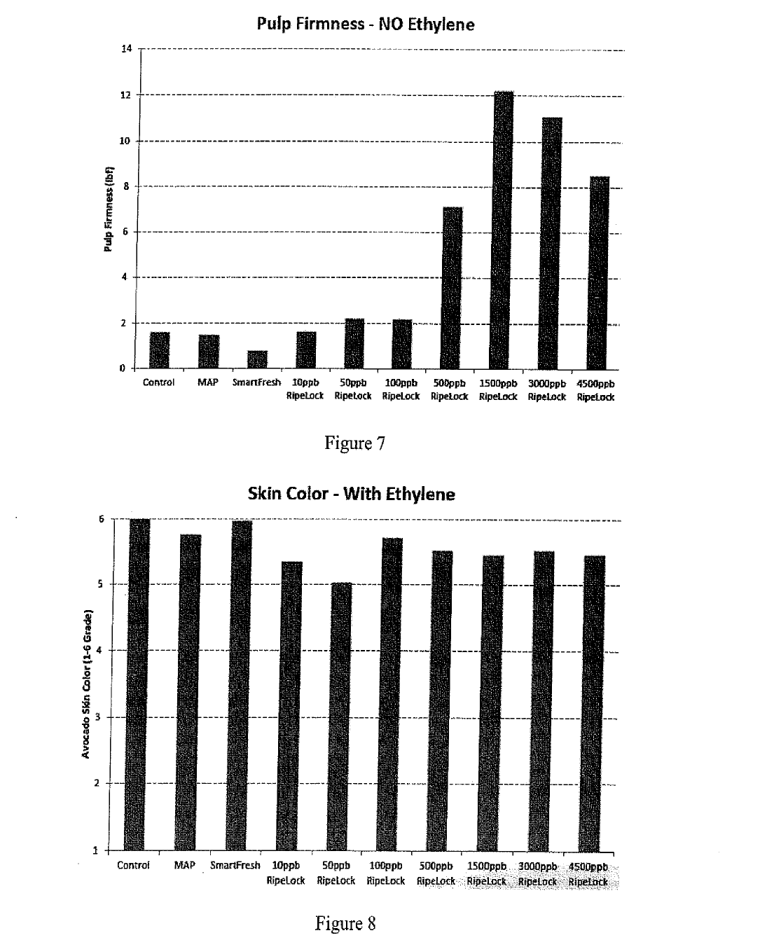

Data of pulp firmness of avocado tested are shown in FIG. 6 (with ethylene) and FIG. 7 (without ethylene). Skin colors of avocado tested are shown in FIG. 8 (with ethylene). The results show synergistic effect for MAP bags and SmartFresh (1-methylcyclopropene or 1-MCP) applications with rates equal or higher than 500 ppb. SmartFresh (1-methylcyclopropene or 1-MCP) application at the rate of 1500 ppb shows best result for both firmness and skin color. The RipeLock applications (combination of MAP bag and 1-MCP application) can keep the fruits firm and green for a longer period of time (i.e., longer shelf-life) than previous methods.

We claim:

1. A method of handling avocados, comprising exposing avocados to an atmosphere that contains a cyclopropene compound, wherein either
(a) the avocados are in a modified-atmosphere package during exposure to the cyclopropene compound, or
(b) the avocados are placed into a modified-atmosphere package after exposure to the cyclopropene compound, and the avocados remain in said modified atmosphere package for at least two hours.

2. The method of claim 1, wherein the modified-atmosphere package is constructed so that the transmission rate of oxygen for the entire package is from 200 to 40,000 cubic centimeters per day per kilogram of avocados.

3. The method of claim 1, wherein the modified-atmosphere package is constructed so that the transmission rate of oxygen for the entire package is from 3,800 to 72,000 cubic centimeters per day per kilogram of avocados.

4. The method of claim 1, wherein the modified-atmosphere package is constructed so that the transmission rate of carbon dioxide for the entire package is from 5,000 to 150,000 cubic centimeters per day per kilogram of avocados.

5. The method of claim 1, wherein the exposure to the cyclopropene compound begins when the avocados have pulp firmness of 65 to 150 Newtons.

6. A method of handling avocados comprising,
exposing the avocados to an atmosphere that contains a cyclopropene compound, wherein the avocados are in a modified-atmosphere package during exposure to the cyclopropene compound and the avocados remain in the modified atmosphere package after the exposure for at least two hours.

7. The method of claim 6, wherein the modified-atmosphere package is constructed so that the transmission rate of oxygen for the entire package is from 200 to 40,000 cubic centimeters per day per kilogram of avocados.

8. The method of claim 6, wherein the avocados remain in the modified atmosphere package after the exposure for at least ten hours.

9. The method of claim 6, wherein the cyclopropene compound during the exposure is at a concentration between 500 ppb and 4500 ppb.

10. The method of claim 6, wherein the cyclopropene compound is in a formulation with a molecular encapsulating agent.

11. The method of claim 10, wherein the cyclopropene compound comprises 1-methylcyclopropene (1-MCP) and the molecular encapsulating agent comprises alpha-cyclodextrin.

12. The method of claim 6, wherein the cyclopropene compound is of the formula: 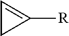
wherein R is a substituted or unsubstituted alkyl, alkenyl, alkynyl, cycloalkyl, cycloalkylalkyl, phenyl, or naphthyl group; wherein the substituents are independently halogen, alkoxy, or substituted or unsubstituted phenoxy.

13. The method of claim 12, wherein R is C₁₋₈ alkyl.

14. The method of claim 12, wherein R is methyl.

15. The method of claim 6, wherein the cyclopropene compound is of the formula: 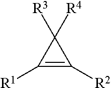
wherein R¹ is a substituted or unsubstituted C₁-C₄ alkyl, C₁-C₄ alkenyl, C₁-C₄ alkynyl, C₁-C₄ cycloalkyl, cylcoalkylalkyl, phenyl, or napthyl group; and R², R³, and R⁴ are hydrogen.

16. The method of claim 6, wherein the cyclopropene compound comprises 1-methylcyclopropene (1-MCP).

17. The method of claim 10, wherein the molecular encapsulating agent comprises alpha-cyclodextrin, beta-cyclodextrin, gamma-cyclodextrin, or combinations thereof.

18. The method of claim 10, wherein the molecular encapsulating agent comprises alpha-cyclodextrin.

19. The method of claim 6, wherein shelf life of the avocados after the exposure is at least thirty days.

20. The method of claim 6, wherein the avocados are placed in the modified-atmosphere package within two hours after harvest.

21. A method of handling avocados comprising,
exposing the avocados to an atmosphere that contains a cyclopropene compound, wherein the avocados are placed into a modified-atmosphere package within two hours after exposure to the cyclopropene compound, and the avocados remain in the modified atmosphere package for at least two hours.

22. The method of claim 21, wherein the modified-atmosphere package is constructed so that the transmission rate of oxygen for the entire package is from 200 to 40,000 cubic centimeters per day per kilogram of avocados.

23. The method of claim 21, wherein the avocados are placed into a modified-atmosphere package within four hours after exposure to the cyclopropene compound

24. The method of claim 21, wherein the avocados remain in the modified atmosphere package after the exposure for at least ten hours.

25. The method of claim 21, wherein the cyclopropene compound is in a formulation with a molecular encapsulating agent.

26. The method of claim 25, wherein the cyclopropene compound comprises 1-methylcyclopropene (1-MCP) and the molecular encapsulating agent comprises alpha-cyclodextrin.

27. The method of claim 21, wherein the cyclopropene compound is of the formula: 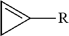
wherein R is a substituted or unsubstituted alkyl, alkenyl, alkynyl, cycloalkyl, cycloalkylalkyl, phenyl, or naphthyl group; wherein the substituents are independently halogen, alkoxy, or substituted or unsubstituted phenoxy.

28. The method of claim 27, wherein R is C₁₋₈ alkyl.

29. The method of claim 27, wherein R is methyl.

30. The method of claim 21, wherein the cyclopropene compound is of the formula: 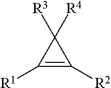
wherein R¹ is a substituted or unsubstituted C₁-C₄ alkyl, C₁-C₄ alkenyl, C₁-C₄ alkynyl, C₁-C₄ cycloalkyl, cylcoalkylalkyl, phenyl, or napthyl group; and R², R³, and R⁴ are hydrogen.

31. The method of claim 21, wherein the cyclopropene compound comprises 1-methylcyclopropene (1-MCP).

32. The method of claim 25, wherein the molecular encapsulating agent comprises alpha-cyclodextrin, beta-cyclodextrin, gamma-cyclodextrin, or combinations thereof.

33. The method of claim 25, wherein the molecular encapsulating agent comprises alpha-cyclodextrin.

34. The method of claim 21, wherein the cyclopropene compound during the exposure is at a concentration between 500 ppb and 4500 ppb.

35. A system for handling avocados comprising,
(a) a cyclopropene compound, wherein the cyclopropene compound is applied to the avocados at a concentration between 10 ppb and 5 ppm; and
(b) a modified-atmosphere package, wherein the modified-atmosphere package is constructed so that the transmission rate of oxygen for the entire package is from 200 to 40,000 cubic centimeters per day per kilogram of avocados.

36. The system of claim 35, wherein the cyclopropene compound is in a formulation with a molecular encapsulating agent.

37. The system of claim 36, wherein the cyclopropene compound comprises 1-methylcyclopropene (1-MCP) and the molecular encapsulating agent comprises alpha-cyclodextrin.
